(19) United States
(12) Patent Application Publication
(10) Pub. No.: US 2006/0265725 A1
(43) Pub. Date: Nov. 23, 2006

(54) Presentation of allocated media on a display device

(76) Inventors: Adam Kyle Barnes, Los Angeles, CA (US); Joshua Ryan Oransky, Studio City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/437,436

(22) Filed: May 19, 2006

Related U.S. Application Data
(60) Provisional application No. 60/683,519, filed on May 20, 2005.

(51) Int. Cl. H04N 7/10

(52) U.S. Cl. 725/32

(57) ABSTRACT

Embodiments of the disclosure include systems and methods for allocating different media within an available display area on a display. For example, an exemplary embodiment includes an allocation device using configurable display rules to allocate the available display area to display content from two or more content inputs.

### CROSS-REFERENCE TO RELATED APPLICATIONS

This application claims a priority benefit under 35 U.S.C. § 119(e) to U.S. Provisional Patent Application No. 60/683,519, filed May 20, 2005. The foregoing application is hereby incorporated by reference in its entirety.

### BACKGROUND OF THE INVENTION

1. Field of the Invention

The present invention relates to the field of displaying electronic media such as digital or other broadcast signals. More specifically, the invention relates to controlling the presentation of electronic media on a display device.

2. Description of the Related Art

Modern consumers can have their attention diverted to or from advertising by a wide variety of media, so advertising that focuses the attention of consumers to a particular media source is becoming increasingly important. Some advertisers use electronic displays to market their products because they can use animation, pictures, scrolling text, etc. to catch the eye. However, when consumers realize that the only content on the display is advertising or information as opposed to, for example, some entertainment content, their attention typically turns elsewhere.

Moreover, when consumers do pay attention to broadcast advertising, they are rarely exposed to advertising that provides options for their immediate environment. In addition, advertisers have been limited in their ability to reach consumers in an immediate environment.

### SUMMARY OF THE INVENTION

Embodiments of the present disclosure include systems and methods for allocating media on display devices. In an embodiment, an allocation device merges programmatic media, such as cable television, with customized media. The customized media, as well as the allocation, can be controlled from, for example, networked computing devices, and in various embodiments, the customized media advantageously comprises localized content. For example, display devices in rooms, bars, common areas, or casino floors of a hotel may allocate a portion of their display area to customized content, such as, for example, specials or deals from vendors within the hotel. For example, a spa, restaurant, bar, taxi service, show, or the like may offer specials designed to entice visitors to leave their rooms and participate in the offerings of the hotel or its surrounding goods and services providers. In another embodiment, a chain of fitness centers may include customized content on a portion of their displays that include offerings of health foods, restaurants, trainer programs, or the like that are of immediate interest to the consumer working out. In still other embodiments, chains of restaurants, bars, or the like, may allocate a portion of their displays to entice viewers to order any type of good or service desired. Thus, embodiments of the present disclosure advantageously allow portions of display areas on display devices controlled by business interest(s) to show content customized for an expected consumer.

In an embodiment, control of the customized content occurs at a centralized location, thereby allowing one, some, or many display devices to include the same or similar customized content. For example, in the context of a large hotel, thousands of room televisions, bar and common area displays, elevator displays, and the like may advantageously be accessed from a central control computer. Moreover, in the context of fitness centers, a fitness center chain may have one gym, a few gyms, or many geographically diverse locations. Centralized control advantageously avoids physically visiting each location.

Embodiments of the present disclosure also include an allocation device comprising video capture, merge processing, and video output between a decoder or receiver device and one or more display devices. Software instructions including user configurable display rules advantageously allocate display area to each of two or more content inputs.

### BRIEF DESCRIPTION OF THE DRAWINGS

The following drawings and the associated descriptions are provided to illustrate embodiments of the present disclosure and do not limit the scope of the claims.

FIG. 1A illustrates the components of a conventional media display system.

FIGS. 1B through 1E illustrate the display areas of display devices of conventional media display systems.

FIG. 2 illustrates a conventional media distribution system.

FIG. 3A illustrates example components of a media display system according to an embodiment of the disclosure.

FIG. 3B illustrates an example display area of a display device of a media display system according to an embodiment of the disclosure.

FIG. 4 illustrates components of an example allocation unit for a media display system according to an embodiment of the disclosure.

FIG. 5 illustrates an example media distribution system according to an embodiment of the disclosure.

FIG. 6 illustrates an example sequence of operating an allocation unit according to an embodiment of the disclosure.

FIG. 7 illustrates an example sequence of allocating media according to an embodiment of the disclosure.

FIG. 8 illustrates example frames on display areas of display devices according to an embodiment of the disclosure.

### DETAILED DESCRIPTION OF THE PREFERRED EMBODIMENTS

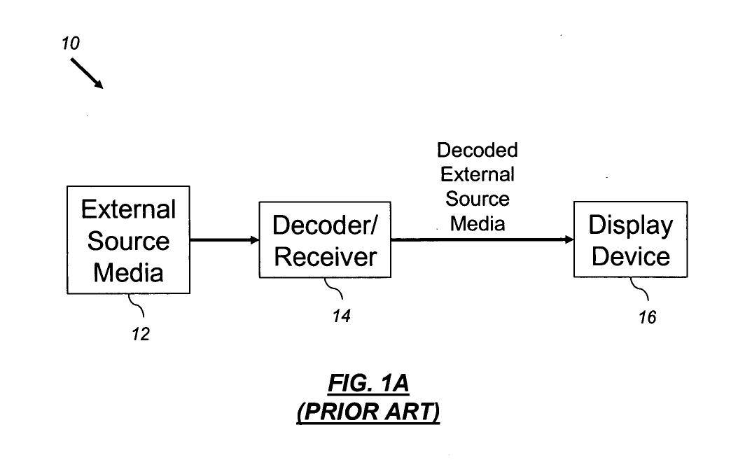

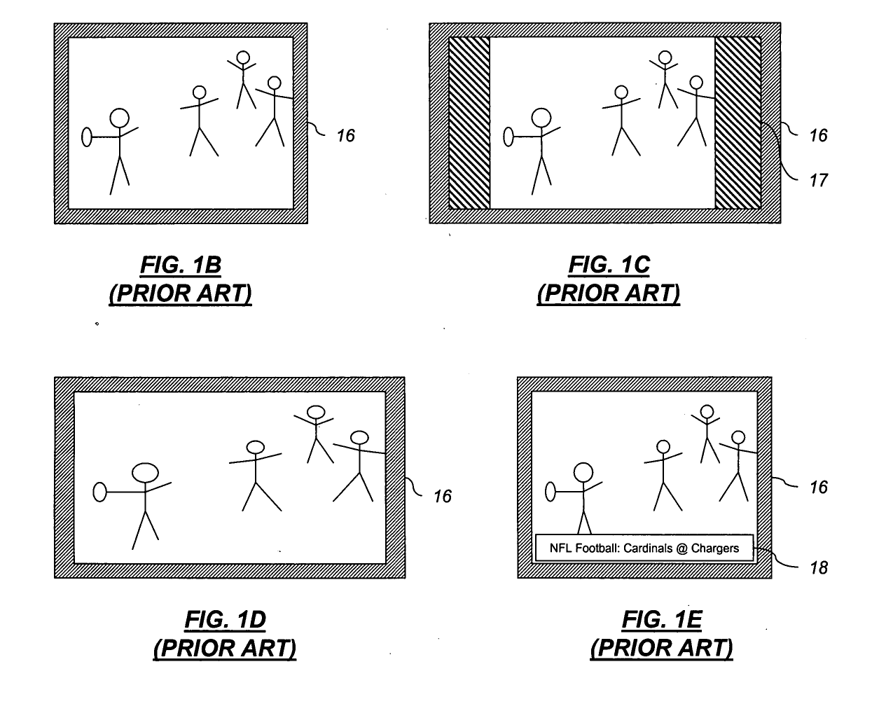

FIG. 1A illustrates the components of a conventional media display system 10. The system 10 includes a conventional display device 16 that can display decoded external source media from a decoder/receiver 14. “External source media,” as used herein, is to be given its ordinary and broad meaning, which includes, but is not limited to, media that contains visual, audio, or audiovisual information. Examples of the external source media 12 include, but are not limited to, a broadcast TV signal, a cable TV signal, a satellite TV signal, an internet signal (e.g., streaming internet audio or video), and a fixed source, such as a video cassette recorder (“VCR”) cassette, a digital versatile disk (“DVD”), a Blueray disk, a high-definition DVD (“HD-DVD”), a moving picture experts group (“MPEG”) (e.g., MPEG1, MPEG2, MPEG3, MPEG4, and MP3), a compact disk (“CD”), an audio cassette, combinations of the same, or the like.

The decoder/receiver 14 generally filters or reduces a broadcast signal to a particular channel, decodes information from a CD, DVD, or the like, thereby outputting the external source media 12 into a format that the display device 16 can understand, herein referred to as “decoded external source media.” Examples of the decoder/receiver 14 include, but are not limited to, a cable box, a satellite box, an HDTV receiver, a digital video recorder (“DVR”) (e.g., TiVo), a DVD player, a Blueray player, a HD-DVD player, a computer (e.g., having a video card, a sound card, a CD drive, a DVD drive, a Blueray drive, and/or a HD-DVD drive), an MPEG player, a CD player, a cassette player, a radio receiver (e.g.; AM, FM, and/or satellite), etc. The decoder/receiver 14 may have one or more inputs, for example to enable viewing of local TV channels from a broadcast antenna and national channels from a satellite provider. The decoder/receiver 14 comprises at least one input. Examples of inputs include, but are not limited to, coaxial cable (e.g., RJ6), composite video baseband signal (“CVBS”), RCA, s-video, digital video interface (“DVI”), component video, video graphics array (“VGA”), combinations of the same, or the like. The decoder/receiver 14 further comprises at least one output, which may be the same or different than the input.

The display device 16 can be any device suitable for displaying visual or audiovisual data. Examples of display devices 16 include TVs (e.g., CRT, LCD, plasma, DLP, projection, etc.), monitors (e.g., CRT, LCD), combinations of the same, or the like. The system 10 may include a plurality of display devices 16, for example by placing a signal splitter between the decoder/receiver 14 and the plurality of display devices 16.

FIG. 1B illustrates the display area of a display device 16 of a conventional media display system 10. The display area exhibits the decoded external source media, for example a broadcast TV sporting event (e.g., a football game as illustrated on the display area of the display device 16 in FIG. 1B). The display area of the display device 16 is typically filled by the decoded external source media.

Some display devices 16 include display hardware that matches or conforms the decoded external source media to a particular available display area. For example, a regular television signal is often provided to fill a display area defined by the National Television System Committee (NTSC), called a “letterbox,” which has a 4:3 width-to-height aspect ratio. However, many televisions have “wide screens,” with a display area defined by a 16:9 width-to-height aspect ratio. When a wide screen display device 16 processes a regular NTSC signal, it may create one or more bars of empty space 17 (e.g., black bars on the sides as illustrated in FIG. 1C) or the wide screen display device 16 may conform the decoded external source media to fill the entire display area. When a wide screen display device 16 conforms decoded external source media to fit the wider display area, the display area may increase by roughly 33%. This increase is calculated by first converting the aspect ratios to decimal values, namely, 4:3 converts to the width being 1.33 times greater than the height, and 16:9 converts to 1.78. Since 1.78 is 33% greater than 1.33, a letterbox image displayed on a wide screen having the same height must be widened by 33% to fill the entire display area, as is commonly done by the display hardware of many wide screen televisions. FIG. 1D illustrates decoded external source media (e.g., the same decoded external source media as illustrated in FIG. 1B) widened to fill the entire display area of a wide screen display device 16.

Some display devices 16 utilize other hardware or a particular display area to dictate conformal processing of the programming signal. For example, in many non-CRT display devices 16, such as LCDs, plasma display, DLP, etc., the display on the display device 16 is comformally processed using capture cards, processors, and video cards. This conformance processing is particularly prevalent when the display area is defined in a computing window environment, where users frequently manipulate the size of the display area (e.g., widening a NTSC signal as described above).

Some decoder/receivers 14 (e.g., cable boxes, satellite boxes, and DVRs) can merge certain types of dependent media with the decoded external source media. “Dependant media,” as used herein, includes its ordinary and broad meaning, which includes, but is not limited to, media that relates to the decoded external source media. An example of dependent media is information about a TV show that can be displayed while the TV show is being broadcast. FIG. 1E illustrates a display device 16 in which the display area contains the decoded external source media and dependent media 18. Another example of dependent media is a channel listing, guide, or menu. A channel listing has little to no value unless displayed with a corresponding decoded external source media. As such, the dependent media 18 is generally designed so that it does not lose relevance to the decoded external source media being displayed. The dependent content 18 therefore usually relies on the provider of the external source media and/or the decoder/receiver 14 (e.g., cable boxes often only work on their endorsed cable systems and satellite boxes typically only work on their particular satellite system).

Media consumers can typically interact with decoders/receivers 14 using remote controls, set-top buttons, etc. to decide what dependent media is displayed on the display device 16. That is, a media consumer may typically disable the dependent content. “Media consumer,” as used herein, includes its ordinary and broad meaning, which includes, but is not limited to, a person viewing decoded external source media on a display device 16. For example, a media consumer may include patrons, employees, and/or visitors that can view a display device 16 in a restaurant. For another example, a media consumer may include guests that can view a display device 16 in a hotel room.

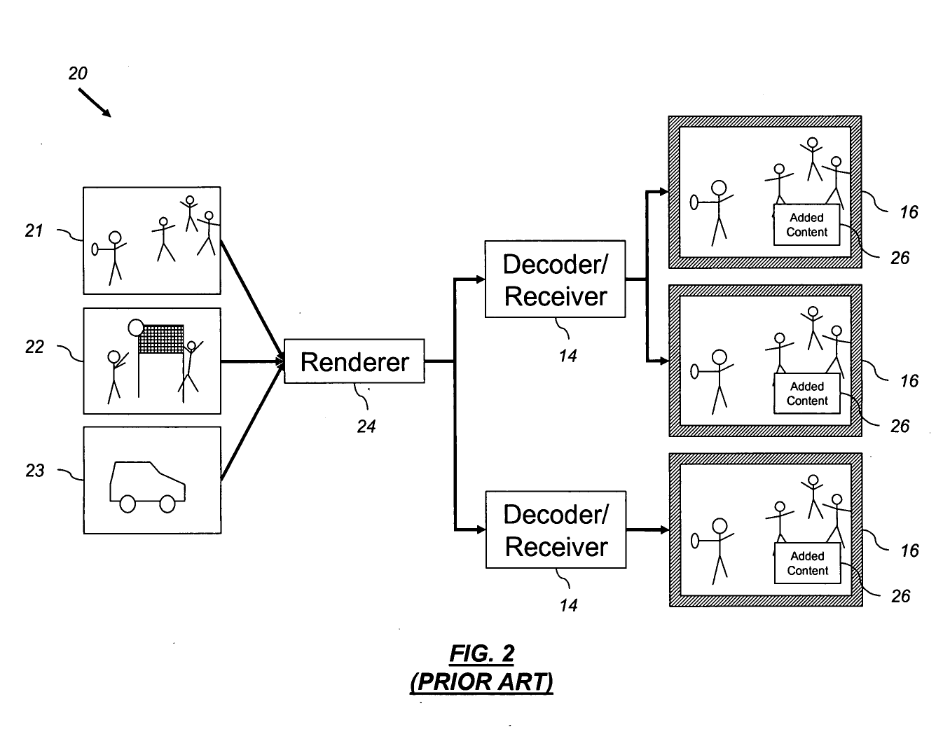

Some systems 20 can merge certain non-dependent media (or “added content”) with the external source media. FIG. 2 illustrates a conventional merged media distribution system 20 where added content has been merged with external source media. Content from external source media 21, 22, 23 (e.g., different TV networks) can be fed into renderer 24. The renderer 24 merges one of the external source media 21, 22, 23 with added content. The merged content is then distributed to merged media consumers (e.g., restaurants, hotels, and car washes), where a decoder/receiver 14 interprets the merged content for display on one or more display device 16. The display area of the display device 16 includes the decoded external source media and the added content 26. The renderer 24 of the system 20 is a broadcaster needing broadcast rights from external source media providers, licensing with the FCC, and the like. Such an arrangement limits the number and types of external source media that systems 20 can display. Moreover, such an arrangement adds overhead due to license negotiation and the like. Additionally, merged media consumers disadvantageously have little to no control over the decoded external source media, the added content, or how they are merged. As such, the added content may be wholly irrelevant to the merged media consumers.

Embodiments of the present invention dispose an allocation unit between the decoder/receiver 14 and the display device 16. The allocation unit arranges external programming, such as cable television, with customized media. The customized media, as well as the allocation, can be controlled from, for example, networked computing devices. In various embodiments, the customized media advantageously comprises localized content. In some embodiments, control of the customized content occurs at a centralized location, thereby allowing one, some, or many display devices 16 to include the same or similar customized content while advantageously avoiding physically visiting each location. Certain embodiments of the allocation unit comprise video capture, merge processing, and video output. Software instructions including user-defined display rules advantageously allocate display area to each of two or more media inputs.

To facilitate a complete understanding of the invention, the remainder of the detailed description describes the invention with reference to drawings, wherein like reference numbers are referenced with like numerals throughout.

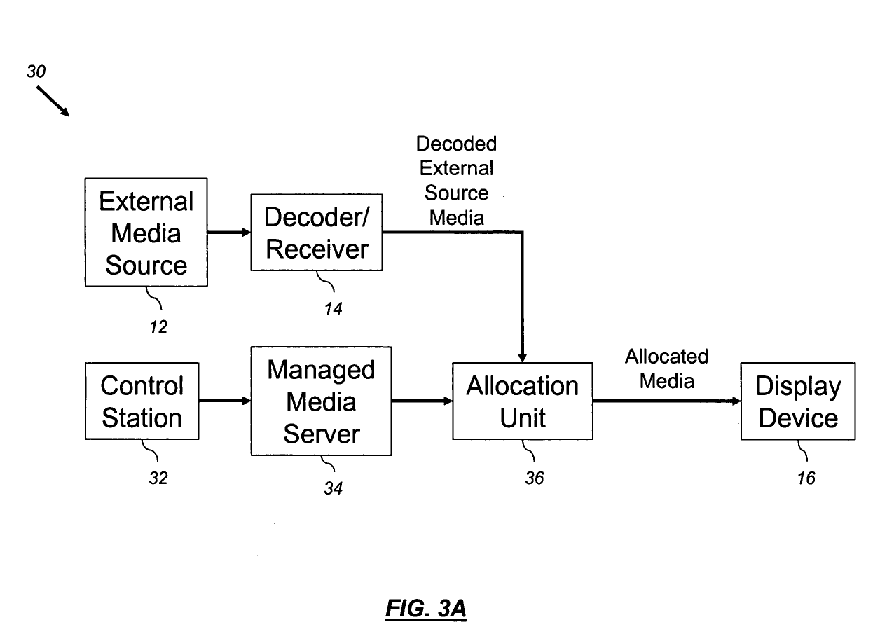

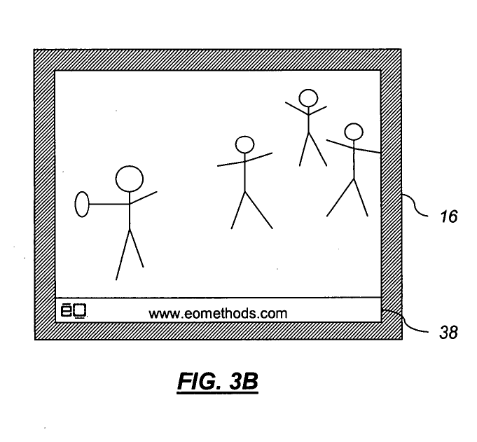

FIG. 3A illustrates example components of a media display system 30 according to an embodiment of the disclosure. The system 30 includes an external source media 12, a decoder/receiver 14, a control station 32, a managed media server 34, and an allocation unit 36. The allocation unit 36 is configured to allocate decoded external source media and managed media and to output the allocated media to one or more display devices 16, for example the allocation unit 36 described below. In a preferred embodiment, the external source media 12, the decoder/receiver 14, and the display device 16 are substantially similar to or the same as the corresponding components in the system 10 of FIG. 1A. In certain embodiments, the decoder/receiver 14 can output the decoded external source media to a plurality of display devices 16, and thus to a plurality of allocation units 36.

The control station 32 comprises a computer including a program for creating, modifying, and/or managing managed media and/or media allocation rules. “Managed media,” as used herein, includes its ordinary and broad meaning, which includes, but is not limited to, media that has been created by a managed media author. Managed media may comprise information, and, more preferably, advertising. Managed media may include text, images, video, multimedia, combinations of the same, or the like. In some embodiments, the control station 32 includes pre-built templates to create the managed media. For example, managed media may comprise standardized media (e.g., frames, disclaimers, and the like) residing on the managed media server 34. Preferably, managed media is accompanied by at least one media allocation rule. “Managed media author,” as used herein, includes its ordinary and broad meaning, which includes, but is not limited to, a person who is responsible for creating, modifying, and/or programming managed media.

“Media allocation rule,” as used herein, includes its ordinary and broad meaning, which includes, but is not limited to, information that provides instructions about how to display and format different types of media. For example, information in a media allocation rule may include how much of the display area of the display device 16 is devoted to managed media versus decoded external source media, whether the managed media overlies decoded external source media, the shape of the managed media, the location of the managed media, the color of the managed media, the font of the managed media, how fast the managed media scrolls, when the managed media is displayed (e.g., constantly, periodically), etc. In some embodiments, the media allocation rule comprises at least some of the managed media. In certain embodiments, the media allocation rules are described in extensible hypertext markup language (“XHTML”), extensible markup language (“XML”), extensible stylesheet language transformation (“XSLT”), other display frameworks such as Flash/ActionScript, Java/Swing, combinations of the same, or the like.

In some embodiments, the media allocation rules are described in an XHTML tabular template defining at least one field. “Field,” as used herein includes its ordinary and broad meaning, which includes, but is not limited to, all or a portion of the display area of a display device 16. Each field may comprise decoded external source media or managed media. In certain embodiments, the field is designed to accept particular types of managed media (e.g., text, graphics, animation, combinations thereof, and the like). In some embodiments, the field is designed to accept managed media from other display frameworks (e.g., Flash or Java). The template describes the layout (e.g., positioning, overlay, and the like) of the fields with respect to each other, as well as any global formatting, thereby allocating the decoded external source media and/or the managed media to the display area of a display device 16.

The control station 32 comprises an input device (e.g., mouse, keyboard, touch screen, stylus, etc.) and a display (e.g., a computer monitor), with which a managed media author may create, modify, and/or manage managed media and/or media allocation rules. In a preferred embodiment, any computer with internet access can act as the control station 32. For example, a computer with internet access may log on (e.g., securely) to a managed media control site in order to create, modify, and manage managed media and/or media allocation rules. In some embodiments, the managed media control site includes templates with which managed media authors may easily create, modify, and manage managed media and/or media allocation rules. Examples of such templates may be commonly used managed media forms, such as text configured to scroll across the bottom of a display area of a display device 16. The templates may thereby simultaneously create the content of the managed media and the media allocation rules.

The media delivery system 30 may comprise a plurality of control stations 32. For example, managed media may be created on a first control station 32 and media allocation rules may be created on a second control station 32. In certain embodiments, the control station 32 includes authorization levels to access the managed media and/or media allocation rules. For example, one authorization level may allow the creation and editing of managed media and media display rules while another authorization level allows communication of the control station 32 with the managed media server 34.

The control station 32 may also comprise a computer dedicated to creating, modifying, and managing managed media and/or media allocation rules. Such a control station 32 would be compatible with one or more operating systems, for example Unix (e.g., Linux, SunOS, Solaris, and Apple OS X), DOS (e.g., MS-DOS), Windows (e.g., Windows 3.0, Windows 3.11, Windows 95, Windows 98, Windows ME, Windows 2000, Windows XP, Windows NT, Windows CE, Windows Server 2003, and Windows Vista), Macintosh (e.g., Mac OS, Mac OS X, and Mac OS X Server), and any other suitable operating system. A program for creating, modifying, and/or managing managed media and/or media allocation rules runs on the operating system, either alone or concurrently with other programs. In certain embodiments, the program interacts with other programs, for example by exchanging text, graphics, and the like. A dedicated control station 32 or plurality of control stations 32 may be appropriate for users with a large plurality (e.g., greater than 1,000 or greater than 10,000) allocation units 36.

The managed media server 34 comprises a computer or a server. “Server,” as used herein, includes its ordinary and broad meaning, which includes, but is not limited to, a computer and storage device dedicated to storing files. Examples of storage devices include flash memory, disk storage such as optical discs, hard disks, floppy disks, and Zip disks, and tape storage. The storage device may be specially formatted to store managed media and/or media allocation rules. The managed media server 34 may be compatible with one or more operating systems, for example Unix (e.g., Linux, SunOS, Solaris, and Apple OS X), DOS (e.g., MS-DOS), Windows (e.g., Windows 3.0, Windows 3.11, Windows 95, Windows 98, Windows ME, Windows 2000, Windows XP, Windows NT, Windows CE, Windows Server 2003, and Windows Vista), Macintosh (e.g., Mac OS, Mac OS X, and Mac OS X Server), and any other suitable operating system. The control station 32 and the managed media server 34 may or may not use the same operating system.

In some embodiments, the control station 32 communicates with the managed media server 34 via direct communication (e.g., COMM port, serial port, universal serial bus (“USB”), firewire, Bluetooth, etc.), an electronic distribution network (e.g., local area network (“LAN”), wide area network (“WAN”)), the internet (e.g., via Ethernet or modem), combinations of the same, or the like. Other communication is also possible. In certain embodiments, the control station 32 is configured to transmit managed media and/or media allocation rules to the managed media server 34. For example, managed media may be created at a control station 32 and uploaded to a managed media server 34. In certain embodiments, the managed media server 34 is configured to retrieve managed media and/or media allocation rules from the control station 32. For example, managed media may be stored at a control station 32, and a managed media server 34 may periodically download files.

In some embodiments, the control station 32 and the managed media server 34 comprise the same unit. For example, an establishment may have one computer with which they create, modify, and manage managed media, and that same computer communicates with the establishment's allocation units 36. Such an embodiment may be useful for establishments without networking capabilities, for enhanced security, and the like.

In a preferred embodiment, the allocation unit 36 periodically connects to the managed media server 34, for example the electronic distribution networks described above. A program running on the allocation unit 36 instructs the allocation unit 36 to retrieve any new and/or flagged managed media and/or media allocation rules. The retrieval may be periodic, for example every week, day, hour, half-hour, and the like, and may be adjusted for each allocation unit 36. The allocation unit 36 may have a serial number which the managed media server 34 may use to identify the allocation unit 36 and to thereby send or not send some managed media and/or managed media rules. For example, serial numbers may be used to distinguish between multiple clients utilizing the same managed media server 34 or to distinguish between the allocation units 36 of a single client (e.g., to differentiate the allocated media according to distinguishing features such as location).

In a preferred embodiment, the allocation unit 36 does not process sound from the decoded external source media. The sound component of the decoded external source media preferably completely bypasses the allocation unit 36, for example coming out of the decoder/receiver 14 and going into directly the display device 16. Such an embodiment preferably prevents distortion of the sound and does not utilize any capacity of the allocation unit 36. In some embodiments, the sound component of the decoded external source media is fed through the allocation unit 36, but is not processed by the allocation unit 36; instead, the sound component of the external source media comes into inputs of the allocation unit 36 that are directly linked to audio outputs of the allocation unit 36. Other setups are also possible.

In some embodiments, the allocation unit 36 comprises a sound card. The sound card may be any suitable computer sound card comprising at least one audio output. Such an embodiment preferably synchronizes the video component of the decoded external source media with the audio component of the decoded external source media. Examples of audio outputs include, but are not limited to, coaxial cable, 3.5 mm, line level out, RCA, digital I/O, etc. In some embodiments, the sound card is AC97 2.2 compliant. In some embodiments, the sound card supports 5.1 channel, 6.1 channel, 7.1 channel audio and/or Sony-Philips digital interface format (“SPDIF”). In some embodiments, the sound card comprises an audio line input. Examples of audio inputs include, but are not limited to, coaxial cable, 3.5 mm, RCA, digital I/O, etc.

The allocation unit 36 may comprise other useful features, for example, IEEE1394 Type A ports, flash memory readers, indicator lights, a power switch, COMM ports, USB ports (e.g., USB v1.1 Universal Host Controller Interface, USB v2.0 Enhanced Host Controller Interface), a RJ45 LAN port (e.g., Realtek RLT8100B 10 T/100 T or 10/100 MB/s), etc. The allocation unit 36 is preferably powered with a 12 V power supply. Skilled artisans will appreciate that other embodiments of allocation units 36 are possible, and that a system 30 is not limited to a particular type of allocation unit 36.

FIG. 3B illustrates an example display area of a display device 16 of a media display system 30 according to an embodiment of the disclosure. The display area exhibits the decoded external source media, for example a broadcast TV sporting event (e.g., the football game illustrated on the display area of the display device 16 in FIG. 1B) as well as managed media 38 (together “allocated media”). “Allocated media,” as used herein, includes its ordinary and broad meaning, which includes, but is not limited to, the media resulting from the use of at least one media allocation rule to format managed media to be displayed with or without decoded external source media. In many embodiments, the allocated media is delivered to media consumers. For example, the allocated media could be a live sporting event (i.e., the decoded external source media) displayed with advertising having text animated on a colored background (i.e., the managed media).

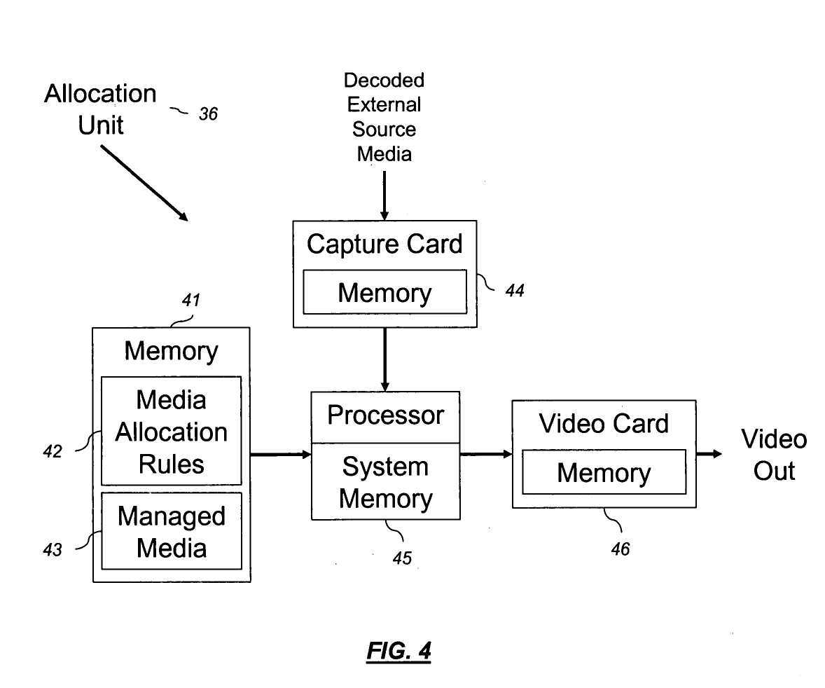

FIG. 4 illustrates components of an example allocation unit 36 suitable for use in the system 30. The allocation unit 36 comprises a memory 41 including media allocation rules 42 and/or managed media 43, capture card 44, processor and system memory 45, and video card 46. The allocation unit 36 is configured to combine decoded external source media and managed media according to at least one media allocation rule, and to output allocated media. It will be appreciated that the allocation unit 36 preferably comprises one or more printed circuit boards capable of communicating between its various components. In a preferred embodiment, a printed circuit board comprises a MV823A VisionPC Mainboard.

In some embodiments, the allocation unit 36 comprises the decoder/receiver 14 or a plurality of decoders/receivers 14. However, because the allocation unit 36 is preferably placed between the decoder/receiver 14 and the display device 16, the allocation unit 36 preferably does not comprise the decoder/receiver 14.

The memory 41 comprises computer memory, such as flash memory (e.g., CompactFlash, Memory Stick, Secure Digital, multimedia card (“MMC”), SmartMedia, USB drive, etc.), disk (e.g., CD-read only memory (“CD-ROM”), CD-recordable (“CD-R”), CD-rewritable (“CD-RW”), DVD, HD-DVD, DVD-recordable (“DVD-R”), DVD-rewritable (“DVD-RW”), DVD plus recordable (“DVD+R”), DVD plus rewritable (“DVD+RW”), DVD random access memory (“DVD-RAM”), Blueray, Minidisc, magnetic hard disk, floppy disk, Zip disk, SuperDisk, etc.), and/or tape (e.g., magnetic tape storage). In certain embodiments, the memory 41 is removable from the allocation unit 36. In certain preferred embodiments, the memory 41 comprises non-volatile computer memory, although some allocation units 36 may comprise volatile memory 41 that is loaded with information after the allocation unit 36 is turned on.

In some embodiments, the managed media server 34 communicates with the memory 41 while the memory 41 is connected to the allocation unit 36 via direct communication (e.g., COMM port, serial port, universal serial bus (“USB”), firewire, Bluetooth, etc.), an electronic distribution network (e.g., local area network (“LAN”), wide area network (“WAN”)), or the internet (e.g., via Ethernet or modem). Other communication is also possible. In some embodiments, the managed media server 34 communicates with the memory 41 while the memory 41 is not connected to the allocation unit 36. For example, communication may be accomplished by connecting the memory 41 to the managed media server 34, transferring the information, disconnecting the memory 41 from the managed media server 34, and connecting the memory 41 to the allocation unit 36. Such a process can be enhanced if the memory 41 is easily removable from the allocation unit 36. Similar communication with the managed media server 34 is possible for other embodiments of allocation units 36.

The capture card 44 comprises a device configured to periodically (e.g., every 1/30^{th} of a second or every 1/60^{th} of a second) acquire a frame of programming from the decoded external source media and to store it in the memory of the capture card 44. Skilled artisans will appreciate that other frame rates are also possible. The memory of the capture card 44 comprises volatile graphic memory such as SGRAM. The frame stored in the memory of the capture card 44 is irrevocably overwritten as soon as a new frame of the decoded external source media is acquired. The capture card 44 comprises at least one input capable of receiving the decoded external source media. Examples of inputs include, but are not limited to, coaxial cable (e.g., RJ6), CVBS, RCA, s-video, DVI, component video, VGA, etc. In some embodiments, the capture card 44 comprises an audio input. Examples of audio inputs include, but are not limited to, coaxial cable, 3.5 mm, RCA, etc. In some embodiments, the capture card 44 comprises at least one of: at least two analog processing circuits including source selection, anti-aliasing filter, static or automatic clamp and gain control, clock generation circuit (“CGC”), analog decoder (e.g., NTSC), digital multi-standard decoder (e.g., phase alternation line (“PAL”), PAL M, PAL N, combination Pal N, NTSC M, NTSC-Japan, NTSC N, and sequential color and memory (“SECAM”)), analog-to-digital converters, automatic switching between analog and digital standards, brightness, contrast, saturation, and hue control, multi-standard vertical blanking interval (“VBI”) data slicer, and 27 MHz VBI data bypass. In a preferred embodiment, the capture card 44 comprises a Philips SAA7113H 9-bit video input processor.

The processor portion of the processor and system memory 45 comprises any computer processor suitable for running a media allocation program. In some embodiments, the processor has a clock speed that can render full screen motion video without significant glitches or aliasing, for example, 400 MHz, 533 MHz, 667 MHz, 733 MHz, 800 MHz, 1.0 GHz, 1.2 GHz, 1.4 GHz, or faster. In some embodiments, the processor has power consumption of, for example, 3 W, 5 W, or 6 W. In some embodiments, the processor has an integrated full speed 192 kB L1/L2 cache. In some embodiments, the processor has a front side bus speed of 100 MHz, 133 MHz, or faster. In some embodiments, the processor has an advanced multimedia instruction set for MMX and/or 3D now. In a preferred embodiment, the processor comprises a VIA C3/Eden 376-pin EBGA package.

The system memory portion of the processor and memory 45 comprises any volatile computer memory suitable for running a media allocation program, for example DRAM, SDRAM, DDR, DDR2, RDRAM, DRDRAM, XDRAM. The memory may be in the form of one SIMM/DIMM or a plurality of SIMMs/DIMMs. In some embodiments, the size of the memory is 64 MB, 128 MB, 256 MB, 512 MB, 1 GB, 2 GB, or more. In a preferred embodiment, the memory comprises one 512 MB bank of PC 1600 or PC 2100 DDR 266 MHz.

The video card 46 comprises any video card capable of outputting the allocated media to the display device 16. The video card 46 comprises at least one video output. Examples of outputs include, but are not limited to, include, but are not limited to, coaxial cable (e.g., RJ6), CVBS, RCA, s-video, DVI, component video, VGA, etc. In some embodiments, the video card comprises at least one audio output. Examples of audio outputs include, but are not limited to, coaxial cable, 3.5 mm, line level out, RCA, digital I/O, etc. In some embodiments, the video card 46 comprises at least one of: optimized Shared Memory Architecture (SMA) with an 8, 16, 32, or 64 MB frame buffer using system memory, an AGP 4X interface, a graphics engine running at 133 MHz decoupled from memory clock, a 128-bit 3D graphics engine, a floating point triangle setup engine, a 3 million triangles per second setup engine, a 133 million pixels per second tri-linear fill rate, an MPEG1, MPEG2, MPEG 3, and/or MPEG4 video decoder, motion compensation for full-speed DVD playback, a hardware-accelerated Slice layer, inverse discrete cosine transform (“IDCT”) and motion compensation, 2D and 3D hardware acceleration, Microsoft DirectX 7.0, 8.0, and 9.0 compatibility, support for OpenGL (e.g., Microsoft or Cosmo), support for Direct3D, resolution up to 1920×1440×16 bit or resolution up to 1366×768×32 bit, VGA resolution support, 16:9 mode, NTSC- (M and J) and/or PAL (B, D, G, H, I, M, N, and Nc) output, and detection of display device 16 presence. In a preferred embodiment, the video card 46 comprises a VIA VT8623.

In some embodiments, the allocation unit 36 comprises a plurality of capture cards 44 and a plurality of video cards 46 that may output the allocated media to a plurality of display devices 16. Such an embodiment is preferable when the processor and system memory 45 are robust enough to process multiple decoded external source media. Such an embodiment is useful for users that have a plurality of centralized (e.g., centrally controlled) decoders/receivers 14 and a plurality of geographically remote display devices 16.

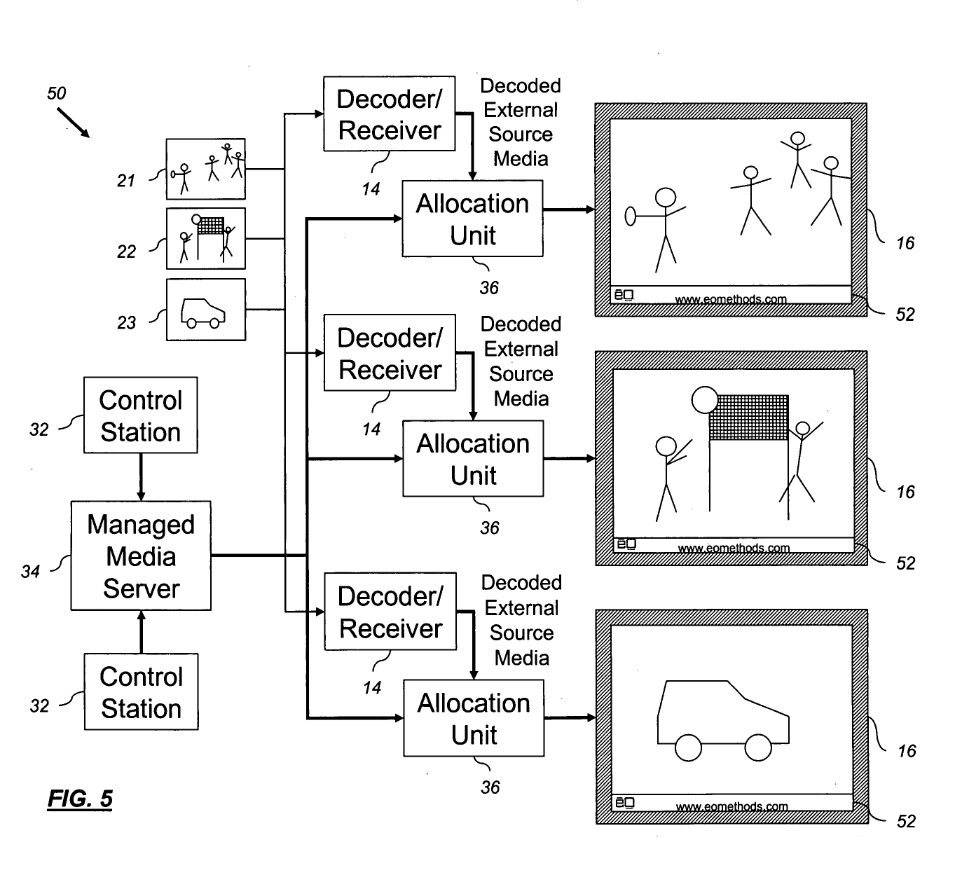

FIG. 5 illustrates an example media distribution system 50 according to an embodiment of the disclosure. An allocation unit 36 may be placed between any decoded external source media and any display device 16. The allocation unit advantageously can allocate a portion of the display area of the display device 16 to managed media 52 regardless of the decoded external source media. For example, one allocation unit 36 may display managed media 52 and a football game, a second allocation unit 36 may display managed media 52 and a volleyball game, and a third allocation unit 36 may display managed media 52 and a NASCAR event, all at the same time using different decoded external source media. Because the allocation unit 36 is not limited to specific decoded external source media (e.g., the few TV networks as illustrated with regard to the system 20 in FIG. 2), the system 50 allows the media consumer control over the decoded external source media. For example, if an allocation unit 36 is placed in a hotel room, a guest of the hotel may switch TV channels at will, and the managed media 52 can still be displayed. As described above, a managed media server 34 may be in communication with all of the allocation units 36, and the managed media server 34 may be in communication with one or more control stations 32. Media distributions systems 50 may be advantageously utilized by users with a large plurality of allocation units 36.

In one example, a bar may have multiple display devices 16 showing broadcast television, movie clips, or DVDs. The bar owner or manager may add managed media, for example drink specials, upcoming events, the availability of pool tables, and the like, to some or all of the display devices 16. The immediate applicability of the information contained in the managed media advantageously allows targeted advertising to a captive demographic. Moreover, the bar owner or manager need not even be present at the bar because the managed media can be communicated to the allocation units 36 from a control station 32 via the managed media server 34. For a chain of bars, the managed media server 34 may utilize, for example, the serial numbers of the allocation units 36 to communicate specific managed media to the allocation units 36. For example, a bar in an urban area may have higher prices than a bar in a rural area.

In another example, a casino may have multiple display devices 16 showing broadcast television in common areas, above gaming tables, and in the sports book. The casino owner or manager may add managed media, for example drink specials, gaming specials, when certain entertainment will occur, and the like, to some or all of the display devices 16. The immediate applicability of the information contained in the managed media advantageously allows targeted advertising to a captive demographic. Moreover, the casino owner or manager need not even be present at the casino because the managed media can be communicated to the allocation units 36 from a control station 32 via the managed media server 34. For a chain of casinos, the managed media server 34 may utilize, for example, the serial numbers of the allocation units 36 to communicate specific managed media to the allocation units 36. For example, one casino may have a special on blackjack while another casino has a special on craps.

In yet another example, a fitness center may have multiple display devices 16 showing broadcast television near equipment, in locker rooms, and at a juice bar. The fitness center owner or manager may add managed media, for example juice bar specials, yoga classes, and the like, to some or all of the display devices 16. The immediate applicability of the information contained in the managed media advantageously allows targeted advertising to a captive demographic. Such a system is particularly suited for businesses like fitness centers to entice customers to spend money beyond their monthly membership fee. Moreover, the fitness center owner or manager need not even be present at the fitness center because the managed media can be communicated to the allocation units 36 from a control station 32 via the managed media server 34. For a chain of fitness centers, the managed media server 34 may utilize, for example, the serial numbers of the allocation units 36 to communicate specific managed media to the allocation units 36. For example, a fitness center in California may have fresh strawberries at the juice bar while a fitness center in Florida has fresh oranges.

In still another example, a hotel may have multiple display devices 16 showing broadcast television in common areas, rooms, restaurants, and bars. The hotel owner or manager may add managed media, for example food and drink specials, facilities such as the pool or fitness center, and the like, to some or all of the display devices 16. The immediate applicability of the information contained in the managed media advantageously allows targeted advertising to a captive demographic. Such a system is particularly suited for businesses like hotels that lure guests out of their rooms to spend additional money on other goods and services. Moreover, the hotel owner or manager need not even be present at the hotel because the managed media can be communicated to the allocation units 36 from a control station 32 via the managed media server 34. For a chain of hotels, the managed media server 34 may utilize, for example, the serial numbers of the allocation units 36 to communicate specific managed media to the allocation units 36. For example, a hotel in a Midwestern state may advertise a steak special at the restaurant while a hotel in a coastal state advertises a tofu special. A system 50 offers substantial advantages for hotels that have bars, casinos, fitness centers, and the like because the allocation units 36 throughout the complex may be centrally or remotely controlled, and may perform at least the tasks discussed above.

The ability to create, modify, and manage content from a plurality of control stations 32 advantageously allows establishments to be controlled nationally and locally. For example, the corporate office of a national chain may provide a portion of the managed media from one control station 32 and the local office may provide another portion of the managed media from another control station 32. The managed media server 34 can be configured to coordinate such usage, for example according to media allocation rules.

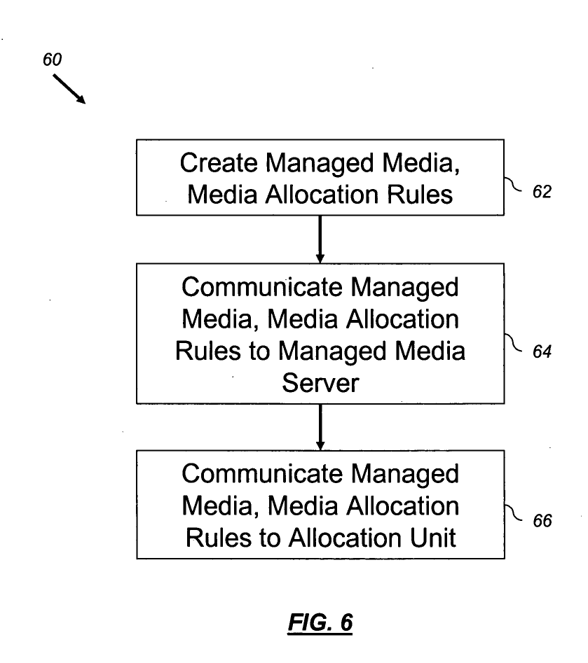

FIG. 6 illustrates an example sequence 60 of operating an allocation unit 36 according to an embodiment of the disclosure. In step 62, a managed media author creates managed media and/or media allocation rules, for example using a control station 32. For example, a managed media author may develop a line of text and a rule that the line of text be scrolled proximate to the bottom of the display area of a display device 16. In step 64, the managed media and/or media allocation rules are communicated to a managed media server 34. An aspect of the communication may be indicating which managed media and/or media allocation rules are should be communicated to one or more allocation units 36. In step 66, the managed media and/or media allocation rules are communicated between the managed media server 34 and the allocation unit 36. The managed media and media allocation rules are stored in the allocation unit 36, for example in memory 41. As described above, communication of the managed media and media allocation rules may be performed by transferring a removable memory 41, or, more preferably, by transmission to the allocation unit 36 over a network. Some or all of the managed media and media allocation rules can be downloaded and stored. The allocation unit 36 can maintain an open connection to the managed media server 34 to receive instantaneous changes, or may periodically (e.g., every week, day, hour, half-hour, and the like) check the managed media server 34 to see if there are any new and/or flagged managed media and/or media allocation rules to download.

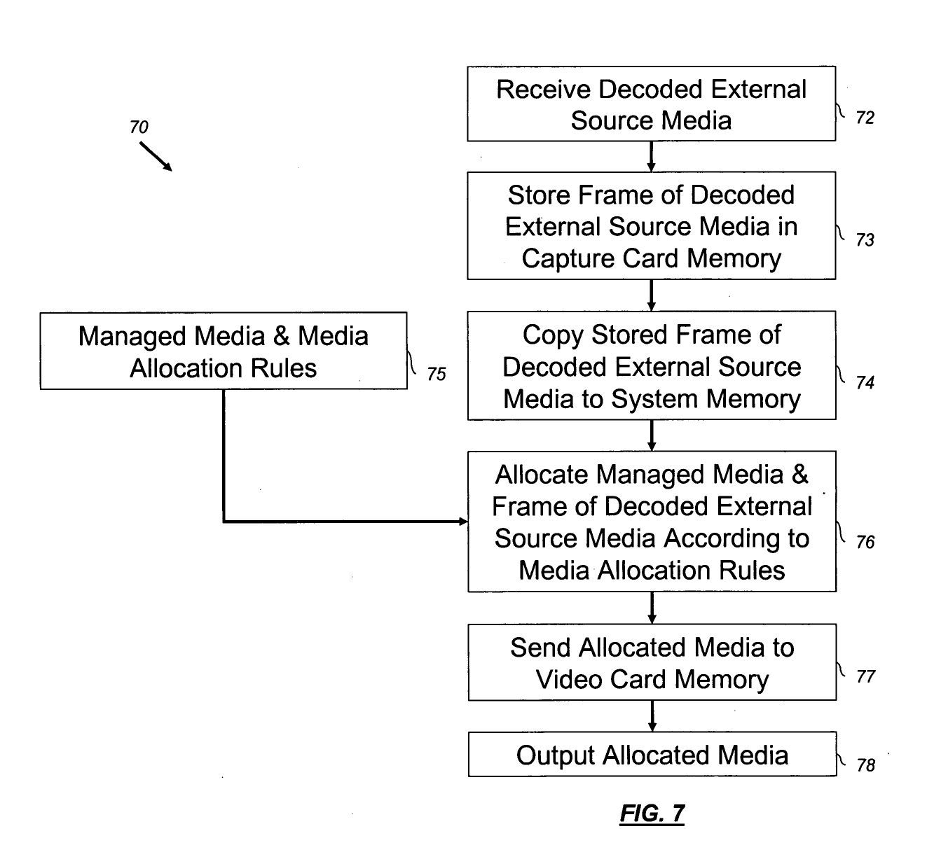

FIG. 7 illustrates an example sequence 70 of allocating media according to an embodiment of the disclosure. Such a sequence may be embodied in a computer program running on the allocation unit 36. In step 72, the allocation unit 36, specifically the capture card 44, receives decoded external source media. Periodically (e.g., every 1/30^{th} or 1/60^{th} of a second), the capture card 44 acquires a frame of programming of the decoded external source media and stores it on the volatile memory of the capture card 44, as illustrated by step 73. Skilled artisans will appreciate that other frame rates are also possible. In certain embodiments, the steps indicated by steps 72 and 73 may occur while new managed media and media allocation rules are communicated to the allocation unit 36. In step 74, the allocation program copies the frame from the memory of the capture card 44 to the volatile system memory. In step 75, the allocation program copies the managed media and the stored in the memory 41 to the system memory. Steps 74 and 75 may occur simultaneously. In some embodiments, step 75 occurs only when the managed media and/or the media allocation rules have changed.

In step 76, the allocation program uses instructs the processor to allocate the frame of the decoded external source media and the managed media according to the media allocation rules, thereby creating allocated media. Step 76 may further utilize the processor to conform the allocated media to a particular display device 16. In step 77, the allocated media is sent to the video memory of the video card 46. In step 78, the allocated media is output to a display device 16 by the video card 46 with the decoded external source media and the managed media allocated to their respective display areas.

The steps 72, 73, 74, 76, 77, 78 are repeated as often as the capture card 44 stores a framed of the decoded external source media (e.g., every 1/30^{th} or 1/60^{th} of a second) while the allocation unit 36 is in operation. Skilled artisans will appreciate that other frame rates are also possible. When the capture card 44 stores a frame of decoded external source media, the frame that was previously stored in the memory of the capture card 44 is irrecoverably overwritten. When the volatile system memory copies the frame of decoded external source media from the memory of the capture card 44, the frame that was previously stored in the volatile system memory is irrecoverably overwritten. The decoded external source media is thereby not stored or fixed for more than a transitory duration, and is effectively “streamed” through the allocation unit 36 unmodified. After the allocated media is displayed, the allocation unit 36 may compile statistics regarding the allocation process 70, which may be periodically transmitted to the managed media server 34 and viewed at control station 32.

In embodiments in which the media allocation rules are described in a display framework, there is generally a template comprising fields that include content. The allocation program analyzes the template. When the allocation program finds a field, it considers the content associated with the field, determines how to suitably display the content, and renders the completed output. As an example, in embodiments in which the media allocation rules are described in an XHTML tabular template defining at least one field, the allocation program analyzes the template layout to find fields, searches for the decoded external source media (e.g., in the memory of the capture card 44) or managed media (e.g., in the memory 41) associated with each particular field, and renders an output signal with the decoded external source media and/or managed media properly laid out with respect to each other in their respective fields. In some embodiments, the allocation program analyzes the media associated with a particular field to determine how to suitably display the media. Skilled artisans will recognize that different or similar techniques may be used for other display frameworks.

In certain embodiments, the allocated media is virtually identical to the decoded external source media that would be displayed without the allocation unit 36. Preferably, there is no change to the programming expression, including, but not limited to, the chronology, screenplay, advertising, presentation, color, luminosity, contrast, dialogue, language, soundtrack, text, graphics, etc. In embodiments in which the only change to the decoded external source media is the display area of the display device 16 none of the decoded external source media is obscured or overlaid with other images. In certain preferred embodiments, the managed media comprises between about 3 and 33%, 5 and 20%, or 8 and 12% of the display area of the display device 16.

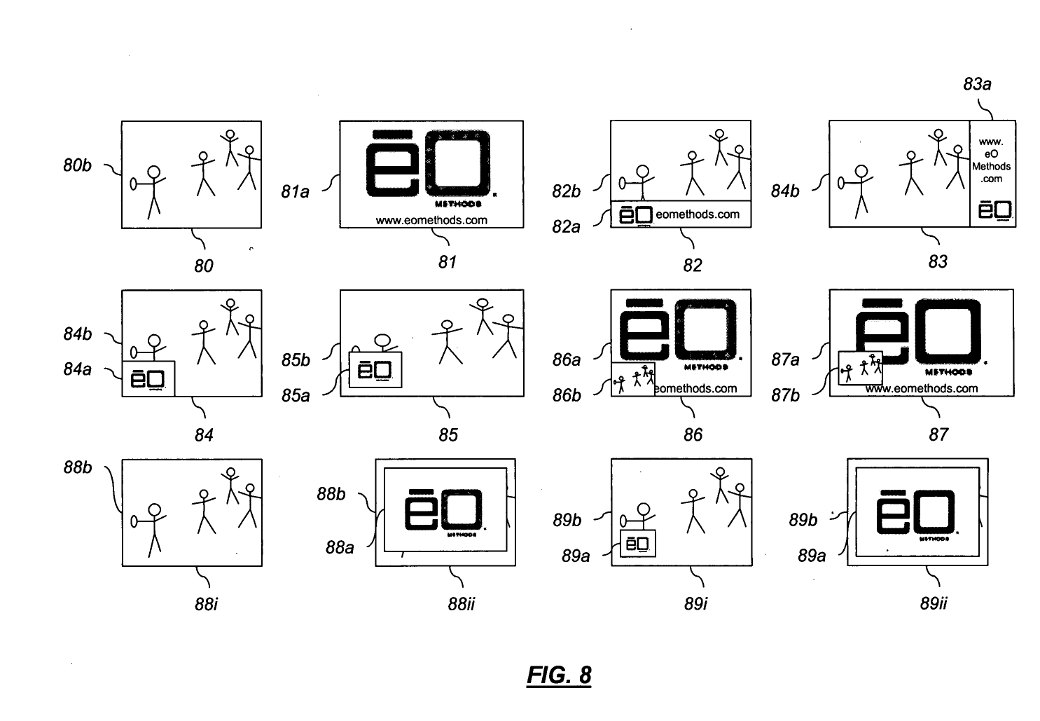

FIG. 8 illustrates display frames 80 through 89 highlighting examples of how decoded external source media and managed media can be allocated on a display device 16, according to an embodiment of the disclosure. The display frames 80 through 89 are schematic only, and various sizes and aspect ratios are not to be limiting. For example, the display frames 80, 82, 84, 86, 88, 89 schematically illustrate screens having an aspect ratio of 4:3, and the display frames 81, 83, 85, 87 schematically illustrate screens having an aspect ratio of 16:9, but the embodiments displayed thereon may be applied to screens with any aspect ratio. The display frame 80 shows an embodiment of a display device 16 exhibiting only decoded external source media 80b (e.g., as if the decoded external source media 80b did not pass through the allocation unit 36). The display frame 81 shows an embodiment of a display device 16 exhibiting only managed media 81a.

The display frames 82 through 89 show embodiments of display devices 16 exhibiting allocated media comprising decoded external source media and managed media. The display frame 82 shows an embodiment of a display device 16 exhibiting managed media 82a in the form of a bar in the bottom portion of the display area of the display device 16 and decoded external source media 82b in the upper portion of the display area of the display device 16. In some embodiments, the managed media 82a overlies the decoded external source media 82b. In some embodiments, the managed media does not overly the decoded external source media; instead, the decoded external source media is not at its native aspect ratio (e.g., as illustrated in FIG. 3B). An allocation unit 36 preferably comprises the ability to overly or not overly managed media with decoded external source media or decoded external source media with managed media regardless of the layout of the allocated media on the display device 16. In certain embodiments, the display area of the decoded external source media 82b is reduced by less than about 33%, less than about 20%, or less than about 10%. Skilled artisans will appreciate that other percentages are also possible. In certain embodiments, the aspect ratio of the decoded external source media 82b is maintained. In certain embodiments, the aspect ratio of the decoded external source media 82b is adjusted from 4:3 to 16:9 or from 16:9 to 4:3. Skilled artisans will appreciate that other aspect ratios are also possible. The managed media 82a may be placed anywhere on the display area of the display device 16, and the managed media 82a need not be anchored to an edge of the display area of the display device 16. Although illustrated as a rectangular block extending the length of the display area of the display device 16, the managed media 82a may be in any shape (e.g., the side of the managed media 82a proximate to the decoded external source media 82b may be curved).

The display frame 83 shows an embodiment of a display device 16 exhibiting managed media 83a in the form of a bar on a side portion of the display area of the display device 16 and decoded external source media 83b in other portions of the display area of the display device 16. A managed media sidebar may have particular advantages when the display device 16 comprises a 16:9 aspect ratio and the decoded external source media has a native aspect ratio of 4:3. In particular, the decoded external source media 83b may be exhibited on the display device 16 without any managed media 83a overlying it or without any change from its native aspect ratio. In such embodiments, the managed media 83a may comprise sidebars on either side of the decoded external source media 83b, or the managed media 83a may comprise a single sidebar with the decoded external source media 83b to one side of the display area of the display device 16 (e.g., as depicted in display frame 83). Skilled artisans will appreciate that other percentages are also possible.

The display frame 84 shows an embodiment of a display device 16 exhibiting managed media 84a in the form of a rectangular block that does not extend the length or the width of the display area of the display device 16. Typically, the managed media 84a in such an embodiment will overly the decoded external source media 84b, but in some embodiments, the aspect ratio of certain portions of the decoded external source media 84b may be adjusted. For example, if the decoded external source media 84b comprises a differentiated portion such as a bar having text and/or animation, the allocation unit 36 may change the aspect ratio of that portion of the decoded external source media 84b to make the managed media 84a appear more integrated. In embodiments in which the managed media 84a overlies the decoded external source media 84b, the managed media 84a preferably does not overly the decoded external source media's logo (or “bug”). However, it will be appreciated that such a preference may be difficult to implement in embodiments in which the media allocation rules are agnostic to the content of the decoded external source media 84b. Although illustrated as a rectangular block, the managed media 84a may be in any shape (e.g., square, circle, polygon). The display frame 85 shows an embodiment of a display device 16 exhibiting managed media 85a in the form of a rectangular block that does not extend the length or the width of the display area of the display device 16 and that does not touch an edge of the display area of the display device 16. Such an embodiment may be advantageous to distinguish the provider of the decoded external source media 85b from the provider of the managed media 85a.

The display frame 86 shows an embodiment of a display device 16 exhibiting decoded external source media 86b in the form of a rectangular block that does not extend the length or the width of the display area of the display device 16. This embodiment allows the managed media author to display a large amount of managed media 86a while advantageously still drawing and keeping the attention of a media consumer due to the presence of the decoded external source media 86b. At least one aspect of the present invention is that managed media authors may advantageously decide the relative sizes and positions of the decoded external source media and the managed media to suit their purposes. The display frame 87 shows an embodiment of a display device 16 exhibiting decoded external source media 87b in the form of a rectangular block that does not extend the length or the width of the display area of the display device 16 and that does not touch an edge of the display area of the display device 16. Such an embodiment may be advantageous to distinguish the provider of the decoded external source media 87b from the provider of the managed media 87a.

The display frames 88i and 88ii show an embodiment of a display device 16 exhibiting managed media 88a in the form of a popup. In such an embodiment, the managed media 88a does not take up any of the display area of the display device 16 (e.g., as depicted in display frame 88i), but periodically takes up a portion of the display area of the display device 16 (e.g., as depicted in display frame 88ii). In some embodiments, the periodicity is designed to coincide with commercials in the decoded external source media 88b.

The display frames 89i and 89ii show an embodiment of a display device 16 exhibiting managed media 89a in the form of highlight. In such an embodiment, the managed media 89a does not take up a significant portion of the display area of the display device 16 (e.g., as depicted in display frame 89i), but periodically expands to take up a more significant portion of the display area of the display device 16 (e.g., as depicted in display frame 88ii). In some embodiments, the periodicity is designed to coincide with commercials in the decoded external source media 89b.

In certain embodiments, the allocation unit 36 can distinguish the content of the decoded external source media. For example, as discussed above, a preferred capture card 44 supports VBI standards, which includes teletext and closed captioning. The allocation unit 36 may use such information, which is typically transmitted with the external source media, to display different allocated media. For example, if the teletext indicates that the external source media is a NASCAR race, the managed media may be an advertisement for automobiles, but if the teletext indicates that the external source media is a cooking show, the managed media may be an advertisement for cookware. In some embodiments, the allocation unit 36 can determine the content of advertising in the decoded external source media to advantageously show competing or non-competing advertising in the form of managed media. For example, if the teletext indicates that the external source media is a Pepsi commercial, the allocation unit may show or not show an advertisement for Coke, depending on user preference and the media allocation rules. In a preferred embodiment, the allocation unit 36 does not distinguish the content of the decoded external source media. In the present disclosure, the managed media can advantageously be agnostic to the type of decoded external source media. Thus, different locations can allocate managed media with the decoded external source media of their choice.

In certain embodiments, the allocation unit 36 comprises the decoder/receiver 14 or a plurality of decoders/receivers 14, thus providing the ability to distinguish between, for example, TV channels. The media allocation rules and/or the managed media may be different for different TV channels. In certain embodiments, the allocation unit 36 comprises a splitter to distribute the allocated media to a plurality of display devices 16. In some embodiments, the video card 46 comprises a plurality of outputs that allow the output allocated media to be distributed to a plurality of display devices 16. In a preferred embodiment, the allocation unit 36 does not include a decoder/receiver 14 or multiple outputs; the allocation unit 36 is only capable of sending the allocated media to the same number of display devices 16 as a system 10 without an allocation unit 36.

For purposes of summarizing the invention, certain aspects, advantages and novel features of the invention have been described herein. Of course, it is to be understood that not necessarily all such aspects, advantages, or features will be embodied in any particular embodiment of the invention.

The foregoing has been described in terms of certain preferred embodiments. Other embodiments will be apparent to those of ordinary skill in the art from the disclosure herein. Additionally, other combinations, omissions, substitutions, and modifications will be apparent to the skilled artisan in view of the disclosure herein. Accordingly, the present invention is not intended to be limited by the reaction of the preferred embodiments, but is to be defined by reference to the appended claims.

What is claimed is:

1. An allocation unit capable of allocating display area of one or more display devices to different media sources, the system comprising:
an input capture device capable of capturing data comprising external source media formatted into a signal usable by a display device;
a processor capable of accessing managed media and programmed to allocate a first portion of the display area to said external source media and allocate a second portion of the display area to said managed media; and
an output card capable of providing an output signal usable by the display device to display said external source media in said first display area and display said managed media in said second display area.

2. The allocation unit of claim 1, wherein the managed media is provided by a managed media server communicating with the allocation unit through one or more networks.

3. The allocation unit of claim 2, comprising a control station capable of managing the content available to the media server and capable of managing the allocation unit.

4. The allocation unit of claim 3, wherein the control station comprises an internet-based program.

5. The allocation unit of claim 3, wherein the control station includes templates to create the managed media.

6. The allocation unit of claim 3, wherein the control station includes user authorization levels.

7. The allocation unit of claim 1, further comprising sound bypass.

8. The allocation unit of claim 1, wherein subject matter of the managed media is independent of subject matter of the external source media.

9. The region of claim 1, wherein said first display area comprises between about 8% and about 12% of the display area.

10. The region of claim 1, wherein said first display area overlays said second display area.

11. A method of providing managed media to an allocation unit, the method comprising:
receiving a display signal capable of causing a display device to display content;
receiving managed content;
receiving a plurality of display rules, one or more of said plurality of display rules allocating display space to said content and to said managed content; and
outputting a merged display signal capable of causing a display device to display said content and said managed content.

12. The method of claim 11, wherein receiving the managed content and display rules is determined by substantially uniquely identifying the allocation unit.

13. The method of claim 11, wherein the merged display signal causes a display device to present said content on a majority of the space and causes a display device to present said managed content on a minority of the space.

14. The method of claim 13, wherein said minority comprises about 8% to about 12% of said space.

15. The method of claim 13, wherein said minority comprises less than about 25% of said space.

16. The method of claim 13, wherein said minority comprises less than about 15% of said space.

17. The method of claim 13, wherein said minority is transitory.

18. The method of claim 13, wherein said minority of said space includes at a bottom most portion of said space.

19. The method of claim 13, wherein said minority of said space includes at least one side most portion of said space.

20. A method of allocating decoded external source media and managed media on a display area of a display device, the method comprising:
receiving managed media and at least one media allocation rule;
copying the managed media and the media allocation rule to a system memory;
receiving decoded external source media;
storing a frame of the decoded external source media in a memory of a capture card;
copying the stored frame of decoded external source media to the system memory;
according to the media allocation rule, allocating the managed media and the frame of decoded external source media stored in the system memory into allocated media;
transmitting the allocated media to a volatile memory of a video card; and
outputting the allocated media to the display device.
